(19) United States
(12) Patent Application Publication
(10) Pub. No.: US 2010/0004993 A1
(43) Pub. Date: Jan. 7, 2010

(54) INTELLIGENT MULTI-MEDIA PLAYER

(76) Inventors: Ann Cameron Troy, Madison, TN (US); Richard Leslie Bandel, JR., Nashville, TN (US)

Correspondence Address: PILLSBURY WINTHROP SHAW PITTMAN LLP, P.O. BOX 10500, MCLEAN, VA, 22102, US

(21) Appl. No.: 12/497,444

(22) Filed: Jul. 2, 2009

Related U.S. Application Data
(60) Provisional application No. 61/218,002, filed on Jun. 17, 2009.
(60) Provisional application No. 61/077,857, filed on Jul. 2, 2008.

(51) Int. Cl. G06Q 30/00

(52) U.S. Cl. 705/14.51; 705/14.55; 705/14.64; 705/14.53; 705/14.66; 705/14.52; 705/14.73

(57) ABSTRACT

Systems and methods for operating an intelligent multi media player are described. The media player can be serialized and registered and connected to a channel that provides content to users of the media player according to affinities and preferences of the user and characteristic of the channel. Content and providing targeted advertisement may be assembled. Advertisements and appearance of the media player typically change for each action associated with the media player, including play, replay and selection of content or advertising material.

### CROSS-REFERENCE TO RELATED APPLICATIONS

The present Application claims priority from U.S. Provisional Patent Application No. 61/077,857 filed Jul. 2, 2008 and titled “Intelligent Multi-Media Player (IMMP)” and from U.S. Provisional Patent Application No. 61/218,002, filed Jun. 17, 2009 and titled “Intelligent Multi-Media Player” which applications are expressly incorporated by reference herein for all purposes.

### BACKGROUND OF THE INVENTION

1. Field of the Invention

The present invention relates generally to multimedia players and more particularly to systems and methods for delivering targeted content based on actions of the media players.

2. Description of Related Art

Devices and communications tools, such as social networking pages or video-sharing website pages, are generally passive in nature, requiring users to go to the content, and provide limited or no ability to automate delivery of new content to the users. Advertising is added to such systems based on instances of content. Where content can be sent to the user or the user notified when new content is available, such as by email newsletter or RSS feed, advertising is affixed to an instance of content. Further, advertising is not generally varied by individual user but is broadcast using a shotgun approach to an aggregated demographic, as is the case of the email newsletter. Another shortcoming of these inventions is than they cannot establish or track relationships between users accessing the same content.

### BRIEF SUMMARY OF THE INVENTION

Certain embodiments of the present invention comprise systems and methods for broadcasting audio and/or visual content to self-selected consumers using available networks such as the internet, cellular networks, WiFi and an internet, or other network-connected devices. Targeted advertising can be selected and distributed based on the number of times the user plays the content, as well as with instances of content or to the invention that conveys the content. Content distributors can track, count and analyze content plays and collect demographic information about content consumers

Certain embodiments of the invention can automate delivery of new content to the users and advertising can be added to such systems based on instances of content and actions associated with the receipt, viewing and playing of the content. Advertising may be targeted and varied for individual users and groups of users.

Certain embodiments establish and track relationships between users accessing the same content. Demographic information can be linked and combined with information derived from e-commerce (e.g. shopping) websites. Subscribers can be connected to other recommending subscribers. Certain embodiments can aggregate selections made by individual users, groups of users and recommending users.

### BRIEF DESCRIPTION OF THE DRAWINGS

FIG. 1 is a flowchart illustrating delivery of enhanced content using an IMMP according to certain aspects of the invention.

FIG. 2 is a flowchart illustrating channel profile setup according to certain aspects of the invention.

FIG. 3 is a flowchart illustrating provision of content in one embodiment of the invention.

FIG. 4 is a flowchart illustrating embedding of an IMMP according to certain aspects of the invention

FIG. 5 is a flowchart illustrating certain functions of an IMMP.

FIG. 6 is a flowchart illustrating assembly of content on an IMMP.

FIG. 7 illustrates a system configurable for use in certain embodiments of the invention.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration.

Certain embodiments of the present invention comprise systems and methods for broadcasting audio and/or visual content to self-selected consumers using available networks such as the internet, cellular networks, WiFi and an internet, or other network-connected devices. Targeted advertising can be selected and distributed based on the number of times the user plays the content, as well as with instances of content or to the invention that conveys the content. Content distributors can track, count and analyze content plays and collect demographic information about content consumers

Certain embodiments of the invention automate delivery of new content to the users and advertising can be added to such systems based on instances of content and actions associated with the receipt, viewing and playing of the content. Advertising may be targeted and varied for individual users and groups of users.

Certain embodiments establish and track relationships between users accessing the same content. Demographic information can be linked and combined with information derived from e-commerce (e.g. shopping) websites. Subscribers can be connected to other recommending subscribers and selections made by individual users, groups of users and recommending users can be aggregated.

In certain embodiments, enhanced content is provided to media players that are adapted according to certain aspects of the invention. Media players may reside in mobile computing devices, which can also function as communication devices. For example, media players may be deployed in cellular telephones, smart phones, PDAs and portable computers. It will be appreciated that each of these example devices is capable of wireless communication and execution of software applications that can enhance and/or augment functionality of the device. Accordingly, media players constructed according to certain aspects of the invention may be installed in such devices and existing media players may be augmented. For example, an agent may be adding to an existing media player on such devices or may be incorporated in a media player for download. Agent typically performs functions of the described invention, including registration and serialization, maintenance of genealogical and other configuration, logging, reporting and other functions. These functions are described in more detail below.

In certain embodiments, users of the systems can self-select audio and/or video content they want to receive, and the system can be configured to notify the subscriber in near real-time as new content matching their self-selections becomes available for their consumption. The system can facilitate a content distributor in targeting advertising for individual users and groups of users. The system may attach fresh advertising to the content with each play and can distribute targeted advertisements and merchandise offers to the media player. Content distributors can, as a consequence of system capabilities, identify the numbers and type of devices employed by a user to access content. The system can track the copying of players from one site or device to another and can maintain a relationship between players. Thus, a content distributor may collect and aggregate demographic information across users and their desired/selected content, advertisement and merchandising choices.

Embodiments of the invention can be configured to provide access levels and permissions for parties using the systems and methods described herein. Content providers typically offer content of interest to different subscribers. For example, a band of musicians may provide video, audio, graphical and written content of interest to fans, other musicians or certain subscribers and users generally interested in music. Interested subscribers may create or configure a channel to receive and distribute content provided by the band. The channel may be shared with other members of a fan club. In another example, the content provided by the band may be added to content form other musicians as, for example a genre-specific channel of interest to other subscribers and users. Subscribers may also create and register media players to receive content from their channel. This media player is uniquely identified in a serialization process and registered. The media player can be copied by the subscriber or by other subscribers and the copied IMMP is provided with its own unique identification and registered. Non-subscribers may use a registered IMMP, although in at least some embodiments, use may be restricted to subscribers only. If an unsubscribed user wishes to copy the IMMP or create a channel, then the user must typically subscribe and be registered with the system. In some embodiments, subscribers may contribute content to a channel although, in other embodiments, content providers must be pre-approved or pre registered as providers. Thus, it is contemplated that embodiments of the invention can be deployed as broadcast systems, pay-per-play, peer-to-peer, social networking and in other forms.

Certain embodiments of the invention comprise systems and methods that interact with subscribers to deliver content, develop and maintain demographic and operational information related to the subscribers and to deliver advertising based on instances of use, or play of the content. In particular, the content may include multimedia content that can be played on an intelligent multimedia player (IMMP) constructed or adapted according to certain aspects of the invention. Each subscriber is typically associated with at least one IMMP, which may be embedded in a computing platform. The computing platform may be a mobile computing device, a desktop computer, an application or component of a desktop computer or mobile computing device, a satellite or cable TV receiver, a CD, DVD, BluRay or other optical media player, a personal media player such as an MP3/MP4 player and so on.

Certain embodiments of the invention facilitate distribution of audio or video content between subscribers using an IMMP, tracking, counting and aggregation of information obtained from the IMMPs, enhancement of content with advertising targeted to the subscriber's demographics, monetizing every play of the content, and mining the content, history, and relationships of an e-commerce cart associated with the IMMP.

In certain embodiments, an IMMP according to certain aspects of the invention enables a content provider to communicate from a portable networkable device such as a cell phone or any telephonic device with many other subscribers. Communication includes broadcasting messages and multimedia content using the Internet as a distribution mechanism. Communication, both audio and/or video can be captured into mobile communications devices such as cell phone, video camera, PDAs, media players, computers and cell phones.

Communication can be captured by an interactive voice recorder (“IVR”) that can comprise IVR intake software. The IVR records the content and disseminates it to the various IMMPs that have subscribed to the content provider. Before distributing the message, the invention matches the content provider to advertising appropriate to the demographics of subscribers who signed up to receive the content. The invention then distributes the advertising with the content.

In certain embodiments, a subscriber acquires an IMMP in software form from an Internet-connected source using a process referred to here as “embedding.” During embedding, the system asks the subscriber for specific information that allows the IMMP to identify the subscriber with a particular device or platform, such as a social-networking page or other HTML page, a game system, or a mobile computing platform. In certain embodiments of the invention, individual IMMPs are verified and counted. At most, conventional systems attempt to verify or count users of media players. Accordingly, each IMMP embed is serialized in systems according to certain aspects of the invention. In certain embodiments, the system may be configured to recognize that one subscriber may have and/or use plural different IMMPs, and a number of points of contact correlated with the number of associated IMMPs may multiply for each subscriber. Each time a subscriber embeds an IMMP into a device, he is asked to identify and qualify the device with subscriber information that can include email, address, age, and phone number. A subscriber's identifying information is typically stored for use by systems such as advertising engines, advertising databases, ecommerce engines, content catalogs and subscriber databases.

### Targeted Advertising

Before distributing content, systems according to certain aspects of the invention can match a content provider to advertising appropriate to the demographics of subscribers who have previously subscribed to receive the content, thus creating new business models for advertising on the Internet. Advertisers can select and target a desired cross section of a demographic. Several features of the system can be used to identify the demographic. For example, individual subscriber demographics can be created when subscribers provide information about themselves when embedding an IMMP. When groups of individuals select similar content, their information can be mined and analyzed to produce audience demographics. A content provider representing and/or providing content created by a source group (such as a musical performance group), may generate and maintain a pre-defined demographic that the system can capture.

Systems constructed according to certain aspects of the invention may use these demographics in many ways. If the content is distributed by a content provider whose audience is between the ages of 11 to 14, the advertising engine can retrieve the demographic data from the system in order to select appropriate advertising. The advertising engine can also block and/or avoid selecting inappropriate advertising such as content marketing alcoholic beverages may be withheld from to 11 to 14 year-olds. It will be appreciated that conventional systems lack such capabilities.

In another example, a self-selecting aspect of subscribers may be useful to advertisers by extending the advertisers reach to their target audience. An advertiser may know that their target audience includes the fans of a particular musical group, but not know that many fans of that group follow another group with a demographic that matches their product. Mining the data collected by the invention may help advertisers find a more extensive target audience.

### Monetization of Every Listen or View of Content

Certain embodiments can maximize the value of the advertising by targeting the advertising to the subscriber, and can also maximize the variety of ads each subscriber sees by displaying a new advertisement each time the subscriber plays any instance of content. Content may be repeated as desired, required or according to configuration. The skin (graphic) of the IMMP can also be changed with each play to provide a fresh impression and to capture the subscriber's attention.

In certain embodiments, advertising on the IMMP can be displayed in any content format supported by standard HTML rendering applications and can include any inherent functions supported by those applications such as hyperlinks to other websites or applications designated by the advertiser. Each time a subscriber clicks on, views or hears content, a new ad may be presented on the IMMP. Therefore, the advertisement may be refreshed even if the subscriber does not click through to the advertisement. Consequently, if a subscriber plays the same content over and over, he will be continuously exposed to fresh advertising content, until the inventory of appropriate ads has been exhausted. This feature contrasts to conventional forms of internet advertising in which an instance of content is married to an instance of advertising throughout its viewing. For instance, if someone loads a video-sharing website page and watches a video, he or she can watch that video for as long as they want without refreshing the screen and without the website monetizing any of the viewings beyond the first one. Thus according to certain aspects of the invention can monetize every play of content, including repeated playing of the same content.

The ability to monetize content plays typically requires tracking subscriber behavior for the purpose of targeting advertising to user demographics. In order to track subscriber behavior, content is connected to the advertisement engine which tracks each subscriber interaction with the player and any selected content. The invention also captures every play of each of the content provider's content.

In certain embodiments, the system comprises an IMMP back end that includes an advertising catalog. The advertising catalog may play a part in monetizing content plays by choosing advertisements targeted to the subscriber both in suitability and variety while maximizing profit to the content provider. The advertising catalog is comprised of an advertising engine, audience profiles, subscriber profiles, and content selection.

In certain embodiments the advertising catalog may be comprised of different categories of advertising in order to maintain a variety of advertising from which the most advantageous advertisement for each content play can be chosen. In one example, a premium advertisement category may be directly related to the content provider whereby the advertiser maintains a relationship with the content provider in the form of a partnership, sponsorship and/or branding relationship. For example, an artist may have an existing relationship in which an advertiser is promoted in content that the artist currently shares with an existing audience. This content could be promotional, branding, product driven, sponsorship, or monetary gains for the content provider. In another example, the advertising catalog may include non-premium advertising that is characterized by a lack of a current relationship with the content provider. A non-premium advertisement may comprise generic advertisements that may still have an association to the content provider through metadata tags and keywords, but will not necessarily have a direct relationship with the content provider.

### Mining E-Commerce Cart Contents, History and Relationships

In certain embodiments, IMMPs may be provided with an e-commerce cart. The cart inherits the contents of the cart belonging to the IMMP from which it was copied. Typically, the cart enables the subscriber to sign up for content. The cart may also contain other types of items, such as merchandise and/or purchasable downloads, such as songs or movies. Features of the cart include inheritability, ability to push items into the cart and ability to read the cart's contents.

Inheritability can be used to identify and track the genealogy of the cart, and thus the IMMP, through its many copies, and to maintain that web of connections, so that at any time the system knows which IMMPs are related to any particular subscriber's IMMP. This knowledge may be used to target advertising or marketing. It is also the method by which the cart's contents are shared from a first IMMP to a second IMMP copied from it.

The ability to push items into the cart allows the system to add selected items to the cart. The system may use the cart genealogy to send an item to all of the carts in a certain family of IMMPs. It might find that the subscriber/owner of one IMMP purchases a certain item from the cart, and share that item with related IMMPs. A company may want to send an offer to all the subscribers who have signed up for content from a particular content provider. Both content sign-up and the offer reside in the cart.

In certain embodiments, genealogy of an IMMP comprises a history of the IMMP that includes relationships with other IMMPs and users of the IMMP. Genealogy is created when an IMMP is registered, copied and used. Genealogy includes a “family tree” identifying relationships between an IMMP registered by a subscriber and subsequent copies of the IMMP. Thus, a parent or original IMMP may be serialized and registered with the system and subsequently copied as descendant IMMPs. Descendant IMMPs may retain certain characteristics of the parent IMMP, including relationships of the parent with other descendant IMMPs, associated channel and subscriber information, user information and histories of activity. A descendant IMMP may be created as a copy from another descendant IMMP and the genealogy may be hierarchical in nature. In certain embodiments, a subscriber may provide access to one or more users, and access may include an ability to make copies of the IMMP and/or copies of copies of the IMMP.

In certain embodiments, genealogy is maintained as the IMMP is copied from one website, application or device to another. Typically, both copy IMMP and its “parent” IMMP retain copies of an updated, current genealogy that reflects the relationship between the pair of IMMPs. Thus, the copy IMMP may be said to inherit the genealogy of the parent IMMP. Moreover, in certain embodiments, the updated genealogy may be disseminated among other IMMPs that are copies of an IMMP from which the parent IMMP originated. Inheritability facilitates the maintenance of a web of connections that can include relationships between copied instances of related IMMPs such that the system can track and be aware which IMMPs are related to a selected subscriber's IMMP. This knowledge can be used to target advertising or marketing. Inheritability can also facilitate sharing the cart's contents between a first IMMP and a second IMMP, typically where the second IMMP is copied from the first IMMP.

It is contemplated that inheritability can be extended to include in a genealogy, relationships between IMMPs registered by subscribers who are affiliated with a group or have a common affinity and/or preference. This group genealogy may be limited to aspects of subscribers related to the common affinity.

The ability to push items into the cart allows the system to add selected items to the cart. The system may use the cart history to send an item to all of the carts in a certain family of IMMPs. In one example, a subscriber/owner of one IMMP may purchase a certain item from the cart, and share that item with related IMMPs. In another example, a company may want to send an offer to all the subscribers who have signed up for content from a particular content provider. Both content sign-up and the offer can reside in the cart.

In certain embodiments, a system can create a more detailed profile of subscribers' preferences and actions by reading the content of the subscribers' respective carts. Because some items in the cart can be self-selecting, data in the cart may be mined and connected to advertising or merchandising that matches the subscriber's profile. The invention has the ability to access an aggregate of items a subscriber has selected that are not connected to a particular website. Thus the selection crosses interest lines and increases audience exposure.

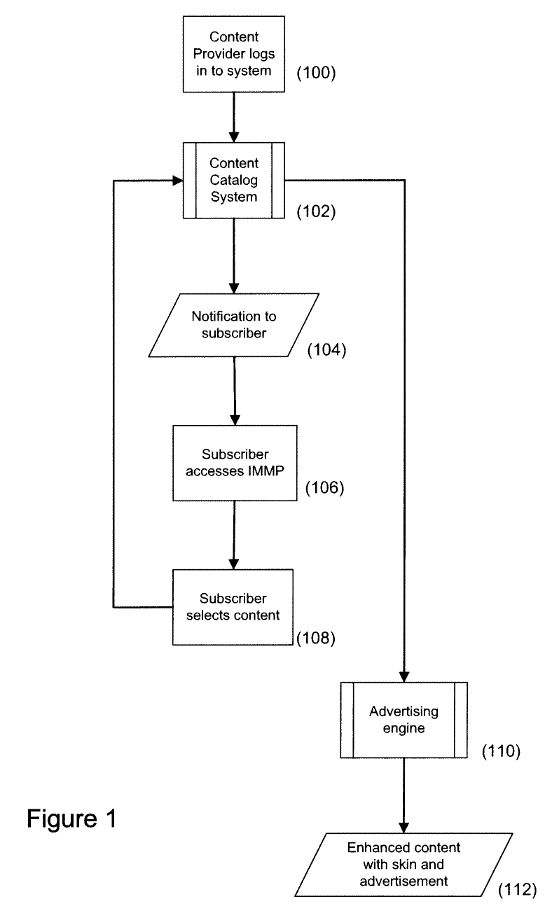

Certain embodiments of the invention provide systems and methods for providing enhanced content to subscribers. FIG. 1 illustrates a process according to certain aspects of the invention, which illustrates how content transmitted by Content Provider 100 can be enhanced and delivered to the subscriber as Enhanced content with skin and advertisement 112 via the IMMP accessed in subscriber access 106. The process in the example of FIG. 1 starts when a Content Provider logs in to system 100, accesses Content Catalog System 102, which can be a software system, via a mobile telephonic device or other web-based device. The mobile telephonic device to which content may be provided may be a Blackberry, a Palm, an I-Phone, a land-line, or any telephonic device as well as other suitably configured mobile computing devices.

When the log-in is completed, Content Catalog System 102 authenticates the content provider and accepts the content. Content may comprise audio and video components. Content Catalog System 102 typically stores the content in an internet-accessible format. Receipt of new content prompts Content Catalog System 102 to send Notification to subscriber 104 notifying him that new content is available for access. Any number of subscribers may have signed up for the content, and Content Catalog System 102 may send a notification to each subscriber signed up for the content.

A subscriber may access an IMMP 106 responsive to the Notification to subscriber 104 or for other reasons. The IMMP accessed in subscriber access step 106 typically comprises a multimedia player that includes a rich content player interface that can be placed on any HTML page as an object. The subscriber may access the IMMP on an internet-connected platform such as a cell phone, computer, interactive television, video game, automobile console, or any internet accessible device.

Upon establishing IMMP access in subscriber access step 106, the subscriber may then select the content he wishes to play in subscriber selection step 108. For example, the subscriber may have chosen to receive content from multiple sources and, accordingly, may find messages representing many instances of content on the IMMP. Subscriber's selection of content 108 prompts Content Catalog System 102 and Advertising engine 110 to assemble Enhanced content with skin and advertisement 112 for presentation to the subscriber. When presented with Enhanced content with skin and advertisement 112, the subscriber may perform one or more actions, including listening to content, viewing the content, clicking on the advertising, and choosing another message to play.

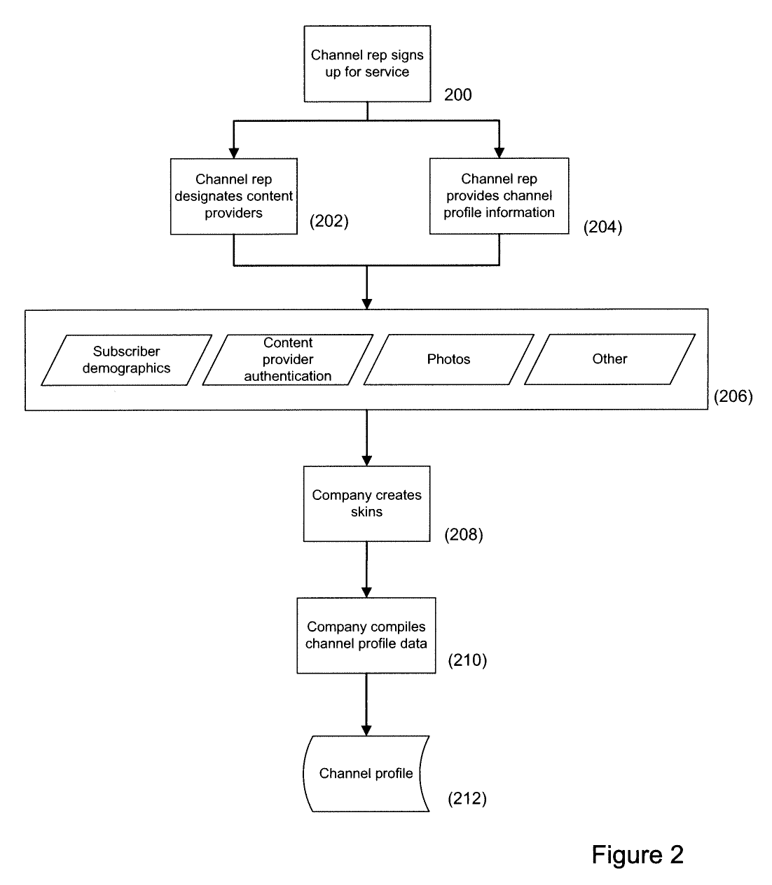

Turning to FIG. 2, a flowchart illustrating setup of a Channel profile is illustrated. A channel representative may enroll for service at step 200. The channel representative can be any person who is authorized to do business on behalf of the channel. A channel may be any person, group or entity that has fans, members, followers, or any associated group of people. For instance, a channel may include performers (either a single performer or a group of performers such as a musical group or the cast of a television show), or a political party. As an example, fans of a musical group may sign up to receive content from the musical group, which is the channel.

The Channel representative can designate one or more content providers at step 202. A content provider has a relationship to the channel, whether as a member, an affiliate or another relationship. As an example, the content providers for a band may be the band members; the content providers for a political party may be the party's candidates or spokespersons. At step 204, the Channel representative provides channel profile information at 206. In the examples described, types of information 206 can include fan or support-base demographics, content provider authentication data, and photographs.

One or more custom skins may be created for the Channel in skin creation step 208. A skin is referred to herein as including software that controls the appearance and functionality of a web page. A skin is used in the assembly of Enhanced content at step 112 in FIG. 1. It will be appreciated that, in some embodiments, a skin may be selected from templates, examples or defaults and may be customized as necessary.

A service provider, aggregator, contractor or other entity (collectively referred to hereinafter as “System Provider”) may compile the channel profile data at step 210. Profile data may include data obtained from channel representative at step 204. In certain embodiments, profile data may include data derived from research come from the company's research. The System Provider typically enters the Channel profile information into a database to create Channel profile 212.

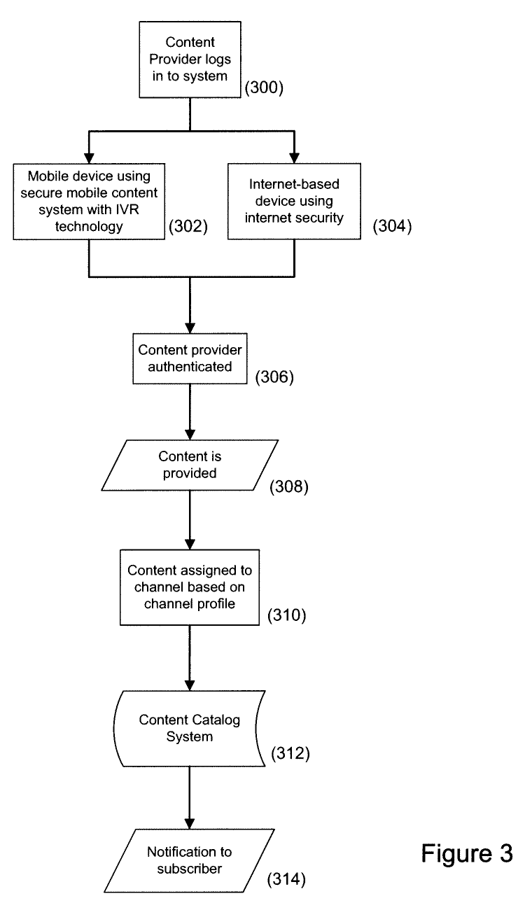

FIG. 3 provides a flowchart of a process according to certain aspects of the invention. The flowchart illustrates how a content provider can provide content. In particular, FIG. 3 illustrates certain steps referenced in FIG. 1, including content provider logging 100, content cataloging 102, and subscriber notification 104.

In certain embodiments, content providers can include any user of a registered IMMP. Subscribers can create, download or otherwise generate a registered IMMP on a suitable computing platform. The IMMP may then be copied to other computing platforms where the copy IMMP may be used by users other than the subscriber, although the subscriber typically uses at least one of the IMMPs. Content generated on the computing platforms may be shared with other IMMPs. Thus, a video camera or a camera on cellular telephone may be used to capture multimedia content that has audio and/or video components. The user of the camera device may then choose to publish the captured content to the channel that distributes the captured content to other IMMPs associated with the channel. In many embodiments, the user of the camera device is a subscriber, although non-subscribing users may view the content of a registered or copied IMMP.

Typically, a content provider who wishes to send content to his channel's subscribers logs into the system at step 300. The Content provider may enter content in two or more ways, including through the use of mobile devices 302 and through general internet access 304. If access is through a mobile telephonic device 302, the Secure Mobile Content system is can be activated to use interactive voice response technology (IVR) to authenticate the content provider using previously acquired and verified security credentials. Identifying data may comprise a combination of device identification and a personal identification number (“PIN”). If access is sought through an internet-based device at step 304, internet-type security can be invoked. Internet security comprises verifying a user through one or more of a user identification number and a password. Other methods of securing connections and authentication can be employed as desired. Upon successful log-in and, having provided valid security credentials, the Content provider is authenticated at step 306. The Content Catalog System may issue a welcome message and instructions.

At step 308, the Content provider typically provides content. The Content provider may be a member of one or more channels and may supply content for any channel of which he is an authenticated member. For example, a political candidate may contribute content to his own channel and may also contribute content to his political party's channel as well. Content may be in audio, video, or graphic format or some other format or a combination of formats. The system may issue a confirmation when the Content provider has completed the content. A Content Catalog system may assign the content to a channel based on the authentication data found in the channel profile at step 310. The authentication data identifies for which channel the content provider has provided content.

The content contributed by the Content provider can be stored in digital or other format on media that is accessible by Content Catalog System 312. Content Catalog System 312 can comprise combinations of hardware, software and firmware and can be used to maintain the content for all channels or substantial of the channels. Content Catalog System 312 may also collect and log data related to the content including, for example, content type and content availability date. Content can be periodically purged from Content Catalog System and archived.

At step 314, the Content Catalog System 312 may notify subscribers that new content is available for access using their IMMPs. In addition, information regarding the contributed content's channel may be provided to the subscribers.

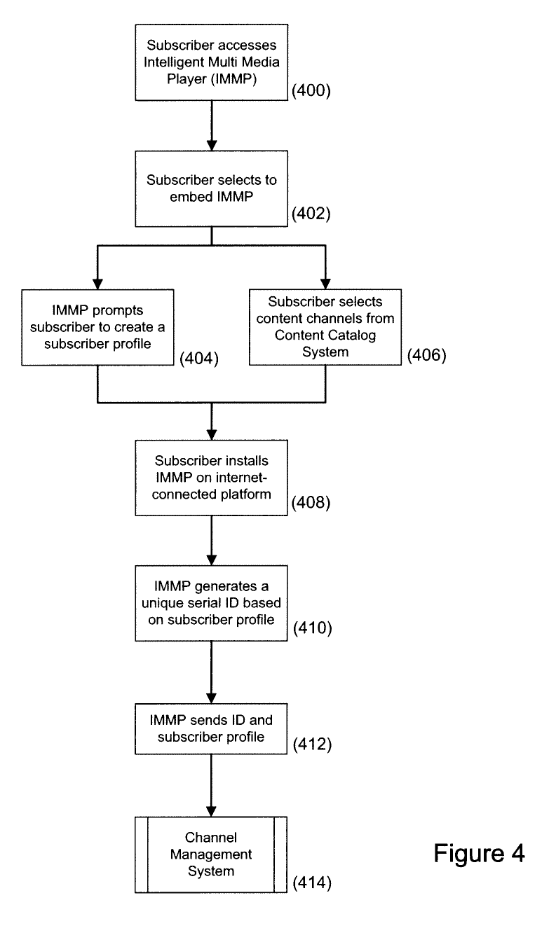

FIG. 4 provides a flowchart showing how a subscriber can embed an IMMP. The subscriber may be required to adapt an IMMP. At step 400, the subscriber may obtain IMMP software or additional components to convert an existing media player to function as an IMMP. The software and/or components may reside on one of many internet-connected sources including, for example, social networking pages, personal or company websites and other HTML objects. Upon subscriber selection, the IMMP may be embedded at step 402. The embedding process may comprise copying and/or reproducing an original or model IMMP for use by the subscriber.

The IMMP embed typically prompts the subscriber to provide information in order to create a subscriber profile at step 404. Information that the subscriber may be asked to provide can include the subscriber's e-mail address, name, age, address, and phone number. The IMMP embed process may also prompt the subscriber to select content channels from the Content Catalog System at step 406. The subscriber's copy of the IMMP may inherit channel selections from the parent copy, which may then be added to, deleted, or modified by the subscriber. At step 408, the subscriber installs the copy of the IMMP produced by the embed process on one or more internet-connected platforms, such as an HTML page, a game system or a mobile computing platform.

At step 410, the IMMP may use the subscriber profile to generate a unique ID with which to serialize the embedded player. A subscriber may serialize multiple instances of IMMPs on different devices which the Channel Management System recognizes as being related to the same subscriber. At step 412, the embedded player sends its serialized ID and associated subscriber profile to the Channel Management System.

Channel Management System 414 typically records the subscriber profile and enrolls the subscriber in the channels he has selected. Channel Management System 414 may also relate this instance of the player to previous instances of the player from which it was copied and can maintain relationships among the various IMMPs.

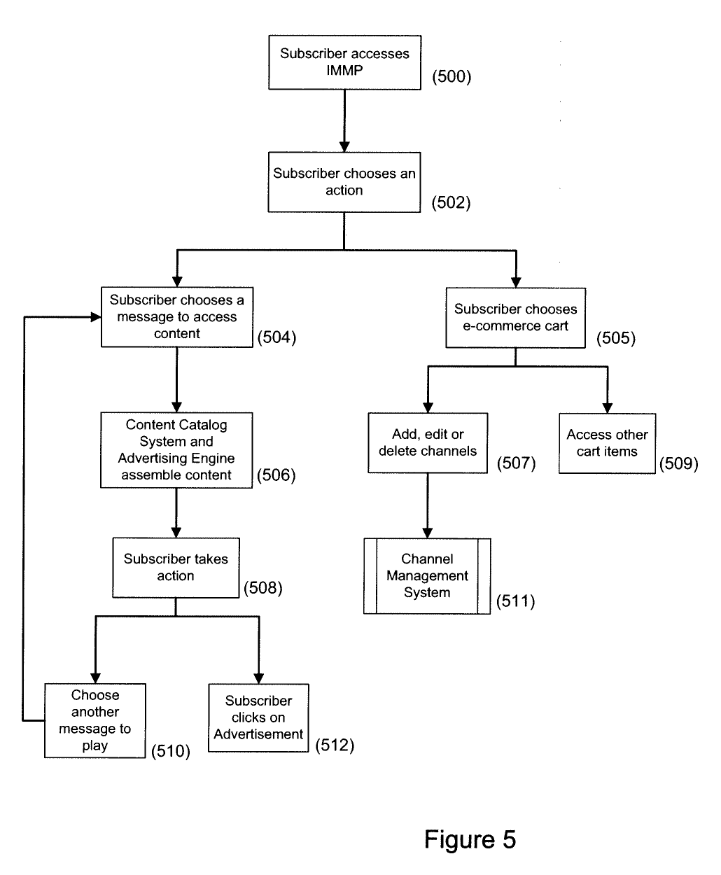

FIG. 5 depicts a flowchart showing functions of the IMMP, including processes for subscriber access to IMMP shown in step 106 of FIG. 1 and subscriber selection of content shown in step 108 of FIG. 1. At step 500, the subscriber accesses the IMMP on an Internet connected platform. Internet connected platforms include cell phones, computers, interactive televisions, video games, automobile consoles, and other such devices. On the IMMP, the subscriber chooses an action at 502. Available actions may include content access 504 and select e-commerce cart 505. Selection of an action typically initiates processes that obtain the subscriber's desired result.

At step 504, selection of “message to access content” may cause the Content Catalog System and the Advertising Engine to assemble the content for immediate presentation at step 506. In addition to content provided in step 308 by the content provider, assembled content may include a message box, a skin and an advertisement. When the IMMP presents the chosen content, the subscriber may take further actions at step 508, with or without pausing to hear/view the content. For example, the subscriber may choose to play another message at step 510 which initiates a sequence of actions commencing once again at step 504. If the subscriber chooses to click on an advertisement at step 512, a number of subsequent actions may be offered including, click through to the advertiser's website or make a purchase. The subscriber may then return to the IMMP to continue choosing actions at step 502.

If, at 502, subscriber chooses e-commerce cart step 505, he may choose one or more further options, including add, edit, or delete channels 507 from his channel selection, and access other cart items 509. Other cart items may comprise advertisements or merchandise offers, and the subscriber may choose to review the cart's contents or make a purchase. The subscriber may then return to the IMMP to continue choosing actions at step 502.

If subscriber chooses e-commerce cart 505, and then chooses to add, edit, or delete channels in step 507, the channel management system may be invoked at step 511 to enact the subscriber's channel changes. The channel management system may authenticate the subscriber's IMMP and record the desired changes. After the subscriber completes add, edit, or delete channels step 507, he may return to the IMMP to continue choosing actions as at step 502.

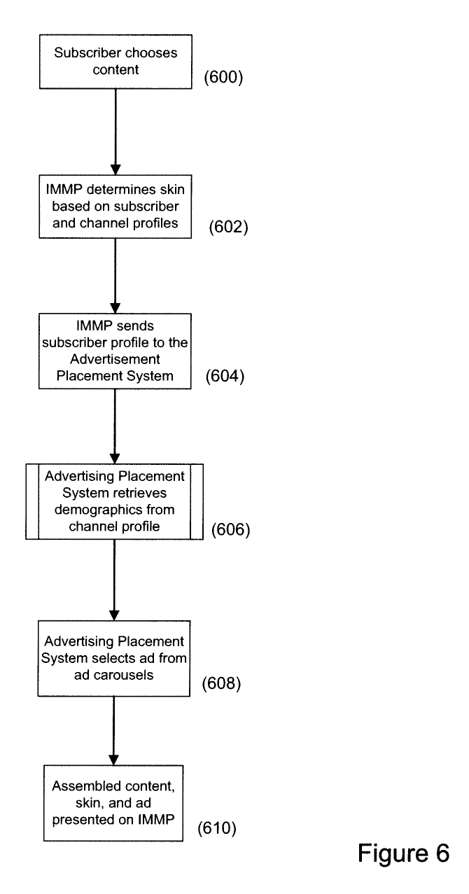

FIG. 6 illustrates a process in which content is assembled on the IMMP using an advertising placement system and the channel and subscriber profiles including processes related to advertising engine step 110 of FIG. 1 that produce enhanced content with skin and advertisement 112 in FIG. 1. At step 600, the subscriber chooses the content he wishes to play by selecting a message on the IMMP. Next the IMMP determines skin based on subscriber and channel profiles at step 602. Each channel typically has one or more skins associated with it. Multiple instances of content may exist for a channel. When possible, the system may assign different skins from the channel's skin inventory for each subsequent message (representing an instance of content) selected by a particular subscriber from a particular channel.

To begin the process of choosing the advertisement, the IMMP sends subscriber profile to the advertisement placement system at 604. The subscriber profile may contain information about the subscriber including, for example, age and geographic location. This information may be used by the advertising placement system to select an advertisement appropriate to the subscriber's situation. The subscriber profile may also contain information about which advertisements have been previously viewed by the subscriber, and the advertising placement system may use this information to vary advertisement presentation.

Next, the advertising placement system may retrieve demographic information from the channel profile in step 606. The channel profile may contain information about the channel's audience, supporters or other followers and the advertising placement system may use this information to select an advertisement appropriate to subscribers to the channel.

At step 608, the advertising placement system may select an advertisement from one or more advertisement carousels using information acquired from subscriber profile and/or content placement preferences designated by the advertiser and contained in the advertiser's profile at step 604 and from the channel profile at step 606. The advertisement carousels may comprise a construct used to categorize ads by their monetary value. Sample carousels include premium, genre, content provider, and low value carousels. The advertising placement system may also capture data about advertisement selection. This data may be used as the basis for a web-reporting system for participating advertisers, as criteria for placing future advertisements, and for other purposes. At step 610, assembled content, skin, and advertisements are presented on IMMP.

### System Description

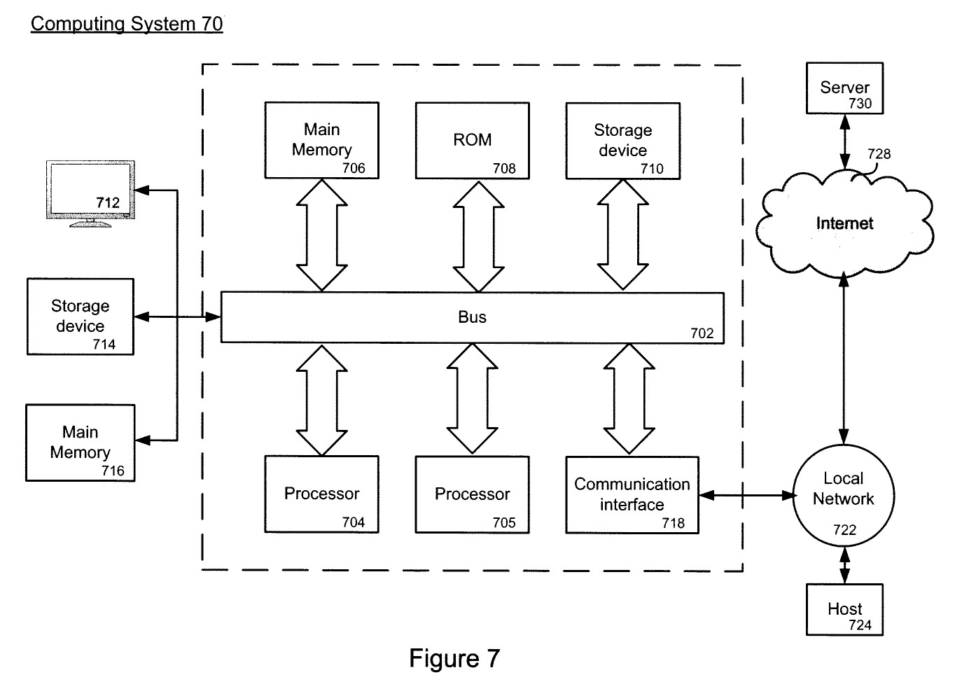

Turning now to FIG. 7, certain embodiments of the invention employ a computing platform 700 that typically comprises at least one processor deployed to perform certain of the steps described above. Computing platform may include a commercially available system that executes commercially available operating systems such as Microsoft Windows®, UNIX or a variant thereof, Linux, a real time operating system and/or a proprietary operating system. The architecture of the computing platform 700 may be adapted, configured and/or designed for integration in the processing system, for embedding in one or more of an image capture system, a graphics processing system, printer or device, including cameras. In one example, computing platform 700 comprises a bus 702 and/or other mechanisms for communicating between processors, whether those processors are integral to the computing platform 700 (e.g. 704, 705) or located in different, perhaps physically separated computing platforms 700.

Computing platform 700 also typically comprises memory 706 that may include one or more of random access memory (“RAM”), static memory, cache, flash memory and any other suitable type of storage device that can be coupled to bus 702. Memory 706 can be used for storing instructions and data that can cause one or more of processors 704 and 705 to perform a desired process. Main memory 706 may be used for storing transient and/or temporary data such as variables and intermediate information generated and/or used during execution of the instructions by processor 704 or 705. Computing platform 700 also typically comprises non-volatile storage such as read only memory (“ROM”) 708, flash memory, memory cards or the like; non-volatile storage may be connected to the bus 702, but may equally be connected using a high-speed universal serial bus (USB), Firewire or other such bus that is coupled to bus 702. Non-volatile storage can be used for storing configuration, and other information, including instructions executed by processors 704 and/or 705. Non-volatile storage may also include mass storage device 710, such as a magnetic disk, optical disk, flash disk that may be directly or indirectly coupled to bus 702 and used for storing instructions to be executed by processors 704 and/or 705, as well as other information.

Computing platform 700 may provide an output for a display system 712, such as an LCD flat panel display, including touch panel displays, electroluminescent display, plasma display, cathode ray tube or other display device that can be configured and adapted to receive and display content to a user of computing platform 700. In that regard, display 712 may be provided as a remote terminal or in a session on a different computing platform 700. For example, an IMMP of a subscriber may share content with another IMMP associated with the subscriber. An input device 714 is generally provided locally or through a remote system and typically provides for alphanumeric input as well as cursor control 716 input, such as a mouse, a trackball, etc. It will be appreciated that input and output can be provided to a wireless device such as a PDA, a tablet computer or other system suitable equipped to display the images and provide user input.

According to one embodiment of the invention, portions of the subscriber interaction with the system may be performed by an application environment supported by computing platform 700. The IMMP may be embedded in computing platform 700 using such environment, which may be an integral part of computing platform 700. For example, a smart phone may support a proprietary operating system and restrict development and deployment of certain applications. In another example, mobile devices may support a standards-based computing platform 700 such as the Java environment provided in cellular telephones. In another example, applications may be developed according to a standard set by the manufacturer and/or service provider that supplies the device. The application environment typically enables commonly used applications to be deployed across a variety of devices and to be configured by users of the devices.

In the stylized platform of FIG. 7, processor 704 executes one or more sequences of instructions. For example, such instructions may be stored in main memory 706, having been received from a computer-readable medium such as storage device 710. Execution of the sequences of instructions contained in main memory 706 causes processor 704 to perform process steps according to certain aspects of the invention. In certain embodiments, functionality may be provided by embedded computing systems that perform specific functions wherein the embedded systems employ a customized combination of hardware and software to perform a set of predefined tasks. One example is a decompression system/media player that can receive compressed audio and/or video content, decompress the content and provide the decompressed content for graphical decoding. Thus, embodiments of the invention are not limited to any specific combination of hardware circuitry and software.

The term “computer-readable medium” is used to define any medium that can store and provide instructions and other data to processor 704 and/or 705, particularly where the instructions are to be executed by processor 704 and/or 705 and/or other peripheral of the processing system. Such medium can include non-volatile storage, volatile storage and transmission media. Non-volatile storage may be embodied on media such as optical or magnetic disks, including DVD, CD-ROM and BluRay. Storage may be provided locally and in physical proximity to processors 704 and 705 or remotely, typically by use of network connection. Non-volatile storage may be removable from computing platform 700 704, as in the example of BluRay, DVD or CD storage or memory cards or sticks that can be easily connected or disconnected from a computer using a standard interface, including USB, etc. Thus, computer-readable media can include floppy disks, flexible disks, hard disks, magnetic tape, any other magnetic medium, CD-ROMs, DVDs, BluRay, any other optical medium, punch cards, paper tape, any other physical medium with patterns of holes, RAM, PROM, EPROM, FLASH/EEPROM, any other memory chip or cartridge, or any other medium from which a computer can read.

Transmission media can be used to connect elements of the processing system and/or components of computing platform 700. Such media can include twisted pair wiring, coaxial cables, copper wire and fiber optics. Transmission media can also include wireless media such as radio, acoustic and light waves. In particular radio frequency (RF), fiber optic and infrared (IR) data communications may be used.

Various forms of computer readable media may participate in providing instructions and data for execution by processor 704 and/or 705. For example, the instructions may initially be retrieved from a magnetic disk of a remote computer and transmitted over a network or modem to computing platform 700. The instructions may optionally be stored in a different storage or a different part of storage prior to or during execution.

Computing platform 700 may include a communication interface 718 that provides two-way data communication over a network 720 that can include a local network 722, a wide area network or some combination of the two. For example, an integrated services digital network (ISDN) may used in combination with a local area network (LAN). In another example, a LAN may include a wireless link. Network link 720 typically provides data communication through one or more networks to other data devices. For example, network link 720 may provide a connection through local network 722 to a host computer 724 or to a wide are network such as the Internet 728. Local network 722 and Internet 728 may both use electrical, electromagnetic or optical signals that carry digital data streams. T

Computing platform 700 can use one or more networks to send messages and data, including program code and other information. In the Internet example, a server 730 might transmit a requested code for an application program through Internet 728 and may receive in response a downloaded application that provides for the anatomical delineation described in the examples above. The received code may be executed by processor 704 and/or 705.

### Additional Descriptions of Certain Aspects of the Invention

The foregoing descriptions of the invention are intended to be illustrative and not limiting. For example, those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure. Certain embodiments of the invention provide asps

Certain embodiments of the invention provide systems and methods for serializing and registering a media player, delivering enhanced content to a media player, cataloging content and providing targeted advertisements to the media player. Some of these embodiments comprise a channel manager that controls access to content by a plurality of users. Some of these embodiments comprise a subscription manager that maintains profiles of subscribers. In some of these embodiments, each subscriber is associated with at least one channel and a plurality of registered media players. Some of these embodiments comprise a content catalog configured to assemble elements of content for a plurality of channels based on the profiles of corresponding associated subscribers. Some of these embodiments comprise an advertising engine that augments channel content with advertising selected based on the content, action notifications received from a registered media player and a profile of a subscriber associated with the registered media player. In some of these embodiments, notifications correspond to one or more actions including requests for an element of the content, initiation of playback of an element of the content and selection of a link provided in the content.

In some of these embodiments, the action notifications are automatically generated by a media player receiving the channel content. In some of these embodiments, the actions cause a change of advertising displayed or provided to the media player. In some of these embodiments, the actions result in a change of appearance of certain aspects of the media player including, for example, a skin change. In some of these embodiments, changes related to actions are directed by a carousel. The carousel may be an advertisement carousel that selects next in sequence advertising based on priority and context of use of the media player and other factors.

In some of these embodiments, the plurality of registered media players includes a media player embodied in a mobile communications device. In some of these embodiments, the mobile communications device contributes content to at least one of the plurality of channels. In some of these embodiments, the mobile communications device is a telephone. In some of these embodiments, the mobile communications device executes one or more user-configured applications. Some of these embodiments comprise a derivative and/or descendant media player that is a copy of a parent registered media player, wherein the descendant media play inherits a genealogy from the parent registered media player that identifies relationships between other copies of the parent registered media player and the parent registered media player. In some of these embodiments, the descendant media player is copied from one of the other copies of the parent registered media player.

In some of these embodiments, each copy of the parent registered media player is serialized with a unique identifier. In some of these embodiments, unsubscribed users can access channel content of a desired channel using a copy of a registered media player associated with the desired channel. In some of these embodiments, the unsubscribed users have a common affinity with a subscriber associated with the desired channel. In some of these embodiments, the advertising engine augments channel content based on activities of the unsubscribed users related to copies of the registered media player. In some of these embodiments, the activities of the unsubscribed users include e-commerce activities. In some of these embodiments, the advertising engine augments the content by adding advertising content to an e-commerce cart. In some of these embodiments, the action notifications are automatically generated by a media player receiving the channel content.

Some of these embodiments comprise serializing an agent in a media player associated with a subscriber. Some of these embodiments comprise assigning a channel to the media player. In some of these embodiments, the channel provides content assembled according to a profile of the subscriber. Some of these embodiments comprise delivering portions of the assembled content to a descendant media player responsive to an action performed on the descendant media player. In some of these embodiments, the descendant media player includes a copy of the agent. Some of these embodiments comprise delivering advertising with the portions of the assembled content. In some of these embodiments, the advertising is selected based on the action and the profile of the subscriber. In some of these embodiments, a user of the descendant media player has an affinity with the subscriber. In some of these embodiments, the profile of the subscriber comprises demographic information of users of the at least one descendant media player. In some of these embodiments, the profile of the subscriber includes information obtained from a plurality of descendant media players. In some of these embodiments, the action includes at least one of initiating playing of an element of the assembled content and repeating playing of an element of the assembled content. In some of these embodiments, action includes initiating viewing of an advertisement using the at least one descendant media player.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. A system comprising:
a channel manager that controls access to content by a plurality of users;
a subscription manager that maintains profiles of subscribers, wherein each subscriber is associated with at least one channel and a plurality of registered media players;
a content catalog configured to assemble elements of content for a plurality of channels based on the profiles of corresponding associated subscribers; and
an advertising engine that augments channel content with advertising selected based on the channel content, action notifications received from a registered media player and a profile of a subscriber associated with the registered media player, wherein
the notifications correspond to one or more actions including requests for an element of the content, initiation of playback of an element of the content and selection of a link provided in the content.

2. The system of claim 1, wherein the plurality of registered media players includes a media player embodied in a mobile communications device.

3. The system of claim 2, wherein the mobile communications device contributes content to at least one of the plurality of channels.

4. The system of claim 2, wherein the mobile communications device comprises a telephone.

5. The system of claim 2, wherein the mobile communications device executes one or more user-configured applications.

6. The system of claim 1, further comprising a descendant media player that is a copy of a parent registered media player, wherein the descendant media play inherits a genealogy from the parent registered media player that identifies relationships between other copies of the parent registered media player and the parent registered media player.

7. The system of claim 6, wherein the descendant media player is copied from one of the other copies of the parent registered media player.

8. The system of claim 6, wherein each copy of the parent registered media player is serialized with a unique identifier.

9. The system of claim 8, wherein unsubscribed users access channel content of a desired channel using a copy of a registered media player associated with the desired channel.

10. The system of claim 9, wherein the unsubscribed users have a common affinity with a subscriber associated with the desired channel.

11. The system of claim 9, wherein the advertising engine augments channel content based on activities of the unsubscribed users related to copies of the registered media player.

12. The system of claim 11, wherein the activities of the unsubscribed users include e-commerce activities.

13. The system of claim 12, wherein the advertising engine augments the content by adding advertising content to an e-commerce cart.

14. The system of claim 1, wherein the action notifications are automatically generated by a media player receiving the channel content.

15. A method for delivering enhanced content to a media player, comprising:
serializing an agent in a media player associated with a subscriber;
assigning a channel to the media player, the channel providing content assembled according to a profile of the subscriber;
delivering portions of the assembled content to a descendant media player responsive to an action performed on the descendant media player, wherein the descendant media player includes a copy of the agent; and
delivering advertising with the portions of the assembled content, wherein the advertising is selected based on the action and the profile of the subscriber.

16. The method of claim 15, wherein a user of the descendant media player has an affinity with the subscriber.

17. The method of claim 16, wherein the profile of the subscriber comprises demographic information of users of the at least one descendant media player.

18. The method of claim 15, wherein the profile of the subscriber includes information obtained from a plurality of descendant media players.

19. The method of claim 15, wherein the action includes at least one of initiating playing of an element of the assembled content and repeating playing of an element of the assembled content.

20. The method of claim 15, wherein the action includes initiating viewing of an advertisement using the at least one descendant media player.
